(19) United States
(12) Patent Application Publication
(10) Pub. No.: US 2018/0249859 A1
(43) Pub. Date: Sep. 6, 2018

(54) SINGLE SERVE CAPSULE, METHOD FOR PRODUCING A SINGLE SERVE CAPSULE, SYSTEM AND METHOD FOR PRODUCING A BEVERAGE

(71) Applicant: K-FEE SYSTEM GMBH, Bergisch Gladbach (DE)

(72) Inventors: Marc Krüger, Bergisch Gladbach (DE); Günter Empl, Bergisch Gladbach (DE); Marco Hanisch, Overath (DE)

(21) Appl. No.: 15/759,304

(22) PCT Filed: Sep. 14, 2015
(86) PCT No.: PCT/EP2015/070965

§ 371 Date: Mar. 12, 2018

(51) Int. Cl. A47J 31/36; A47J 31/40; B65D 85/804

(52) U.S. Cl. CPC A47J 31/3628; B65D 85/8043; A47J 31/407

(57) ABSTRACT

The invention relate to a single serve capsule (1) for producing a beverage in a beverage preparation machine (10), said capsule having an essentially frustoconical or cylindrical capsule base body (2) which has a cavity (3) for receiving a raw beverage material, and a membrane (4) sealing she cavity (3), said capsule base body (2) has a capsule base (5). A central area of weakness (6) having a reduced material thickness is formed in the capsule base (5) which can be perforated by perforation means (11) of the leverage preparation machine (10).

### PRIOR ART

The preparation of beverages by means of what are known as single serve capsules in corresponding beverage production machines is well known from the prior art. Such beverage production machines, also referred to as single serve coffee machines, are known for example from the documents WO 2011/147 553 A1 or WO 2011/147 491 A1, while typical single serve capsules are known for example from the documents WO 2012/038 063 A1 and WO 2010/085 824 A1.

The user always feeds a single serve capsule filled with a beverage raw material into the beverage production machine, subsequently closes the beverage production machine, and starts the preparation mechanism. When the beverage production machine is closed, the single serve capsule is perforated at at least two points, wherein hot water is introduced under pressure into the interior of the single serve capsule through one of the two perforation openings and the beverage is produced by the hot water interacting with the beverage raw material, said beverage flowing out of the single serve capsule through the other of the two perforation openings and being guided into a corresponding drinking vessel. A drawback of these single serve capsules is that the capsule bottom is usually formed in a relatively thick and stable manner, and so the perforation means for perforating the capsule bottom is subject to a high level of wear.

### SUMMARY OF THE INVENTION

Therefore, it is the object of the present invention to provide an easily producible and cost-effective single serve capsule for a beverage production machine, with which the increased wear on the perforation means can be obviated and reliable piercing of the single serve capsule is ensured.

The object of the present invention is achieved by a single serve capsule for producing a beverage in a beverage production machine, having a substantially frustoconical or cylindrical main capsule body which has a cavity for accommodating a beverage raw material, and a membrane closing off the cavity, wherein the main capsule body has a capsule bottom, and wherein a central weakened region with a reduced material thickness is formed in the capsule bottom, said weakened region being able to be perforated with the aid of a perforation means of the beverage production machine.

Compared with the prior art, the single serve capsule according to the invention has the advantage that, at the point in the capsule bottom at which the single serve capsule is perforated by the perforation means of the beverage production machine, a weakened region with a reduced material thickness is formed. The penetration of the capsule bottom thus requires much less application of force, and so the load on the perforation means is reduced and the lifetime thereof is increased. In addition, the weakened region can be configured in a large enough manner for a larger opening to be formed in the capsule bottom upon perforation of the capsule bottom than in the case of the perforation of an unweakened capsule bottom. The single serve capsule can also be produced cost-effectively in that the weakened region, to be perforated by means of the perforation means of the beverage production machine, in the capsule bottom is produced integrally with and from the same material as the rest of the main capsule body. Advantageously, the main capsule body is produced in particular in a thermoforming process. In this case, the main capsule body is produced by thermoforming such that, during thermoforming, a region of reduced material thickness for forming the weakened region is formed in the capsule bottom. This can take place for example by way of a corresponding shaping element in a thermoforming tool. The single serve capsule is thus producible comparatively easily, quickly and cost effectively. The term “thermoforming” within the meaning of the present invention includes preferably any shaping operation of the main capsule body in which plastic deformation of the capsule starting material takes place to form the main capsule body. Shaping can take place for example by negative pressure, by positive pressure, by a stamp or a sonotrode, with application of heat and/or the like. The beverage raw material comprises in particular coffee powder or coffee granules (preferably ground roasted coffee), chocolate powder, milk powder, tea, soup powder or the like. Alternatively, it is conceivable for the beverage raw material to comprise a beverage extract, for example instant coffee.

Advantageous configurations and developments of the invention can be gathered from the dependent claims and from the description with reference to the drawings.

Optionally, the single serve capsule has a filter element which is arranged between the capsule bottom and the beverage raw material. The filter element preferably comprises a textile made of natural and/or synthetic fibers, for example a paper, a nonwoven or a felt. In the event that a felt and a nonwoven are provided, these are preferably Joined together. The felt and/or the nonwoven can be configured in a single-ply or multi-ply manner. Preferably, the filter element comprises a spot calendered material produced from fibers.

Furthermore, one or more insert elements, for example a further filter element, a liquid distributor, a barrier sheet and/or the like, can also be provided in the cavity.

The main capsule body preferably has, on a side remote from the capsule bottom, also referred to as the filling side, an encircling capsule flange to which the membrane is fastened. The capsule lid is adhesively bonded or welded to the truncated cone in the region of a capsule flange.

It is conceivable for the single serve capsule to be formed in a filter-free manner, wherein the beverage raw material rests in particular directly on the capsule bottom. The single serve capsule is in particular configured in a filter-free manner when the beverage raw material comprises instant powder.

In one preferred embodiment of the present invention,
the single serve capsule is configured in a filter-free manner, wherein the weakened region is configured in a substantially circular manner, and wherein the diameter of the weakened region is between 10 and 25 percent, preferably between 15 and 20 percent, and particularly preferably substantially 17 percent of the diameter of the capsule bottom. In particular, the diameter of the weakened region is between 4 and 7 millimeters, preferably between 4.5 and 6 millimeters, and particularly preferably substantially 5 millimeters. The diameter of the capsule bottom spans in particular 25 to 35 millimeters, preferably 28 to 32 millimeters, and particularly preferably substantially 30 millimeters. Advantageously, the diameter of the weakened region is thus large enough for a correspondingly large beverage outflow to be formed when the capsule bottom is perforated. The formation of this comparatively large beverage outflow has the advantage that the beverage does not spray out of the single serve capsule under high pressure and at a correspondingly high speed. In this way, the risk of the immediate vicinity of the beverage production machine being soiled or the user being scalded during production of the beverage is obviated. In addition, if required, the formation of a foam or crema Sayer on the produced beverage can be prevented.

In one preferred embodiment of the present invention,
the material thickness in the weakened region is between 20 and 70 percent, preferably between 30 and 60 percent, and particularly preferably substantially 50 percent of the material thickness in the region of the remaining capsule bottom. It has been shown that the proposed dimensions allow easy perforation of the capsule bottom that is gentle to the perforation means, while at the same time, aroma-tight and shock-resistant closure of the single serve capsule is ensured.

In one preferred embodiment of the present invention,
the capsule bottom is formed at its circumference an encircling reinforcement bulge which protrudes outward in an opposite direction to the membrane. Advantageously, the stability, impaired by the weakened region, of the capsule bottom can be compensated by the encircling reinforcement bulge.

A further subject of the present invention is a method for producing the single serve capsule according to the invention, wherein, in a first production step, a starting material is arranged in the region of a mold of a thermoforming tool, wherein, in a second production step, the starting material is drawn and/or pressed into the mold by means of negative pressure and/or by means of a movable stamp, with the result that the frustoconical or cylindrical main capsule body is formed from the starting material, wherein, in the second production step, material in the region of the capsule bottom is displaced by means of a shaping element in order to form the weakened region.

The method according to the invention allows particularly cost-effective production of the single serve capsule, since the weakening in the capsule bottom is already formed during the thermoforming of the main capsule body. After thermoforming, the main capsule body is filled with the beverage raw material and subsequently closed off by the membrane. It is conceivable for the thermoforming process to be carried out with application of heat. Optionally, the main capsule body is cooled during or after thermoforming. The shaping element comprises in particular a bulge for displacing thermoformed material in the weakened region. To this end, the shaping element is formed centrally on the stamp or on a stamp counterpart as far as which the stamp is moved in the second production step. Preferably, both a shaping element is formed on the stamp and a corresponding shaping element is formed on the mold or on a stamp counterpart, such that material displacement in the weakened region is achieved on both sides of the capsule bottom in the thermoforming tool. The stamp is configured in particular in a cylindrical or frustoconical manner. Alternatively, it is also conceivable for one of the two opposite shaping elements to be configured in the form of a recess into which the opposite shaping element, configured as a bulge, engages when the molding tool is closed. It is also conceivable for the shaping element to be formed in a movable manner on the stamp or on the stamp counterpart and to be extended only during the second production step. Alternatively, it may also be possible for the shaping element to comprise a nozzle, for example on the stamp or on the stamp counterpart, said nozzle displacing material by means of positive pressure or negative pressure in order to form the weakened region.

A further subject of the present invention is a system having a beverage production machine and the single serve capsule according to the invention, wherein the beverage production machine has a first and a second brewing chamber element, wherein the first and/or the second brewing chamber element is/are movable between a loading position, in which the first and the second brewing chamber element are spaced apart from one another in order to introduce the single serve capsule into the beverage production machine, and a working position, in which the first and the second brewing chamber element have been moved together in order to form a substantially closed brewing chamber, wherein the second brewing chamber element has the perforation means protruding in the direction of the first brewing chamber element, said perforation means penetrating the capsule bottom in the weakened region when the beverage production machine is transferred from the loading position into the working position, in order to produce a beverage outflow.

Advantageously, in the system, excess wear to the perforation means is prevented in that the single serve capsule has the weakened region in the capsule bottom. The perforation means produces in the capsule bottom in particular the beverage outflow, through which the produced beverage can leave the single serve capsule.

In one preferred embodiment of the present invention,
the first brewing chamber element has a plurality of further perforation means protruding in the direction of the second brewing chamber element, said further perforation means penetrating the membrane when the beverage production machine is transferred from the loading position into the working position, in order to form inlet openings. Advantageously, the further perforation means produce openings in the membrane, through which brewing water can be introduced under pressure into the single serve capsule.

A further subject of the present invention Is a method for producing a beverage with the system according to the Invention, wherein, in a first method step, the beverage production machine is provided in the loading position, wherein, in a second method step, the single serve capsule is fed to the beverage production machine, wherein, in a third method step, the beverage production machine is transferred from the loading position into the working position, with the result that the perforation means penetrates the weakened region and the capsule bottom is perforated, and wherein, in a fourth method step, brewing water is forcibly fed to the single serve capsule.

Further details, features and advantages of the invention can be gathered from the drawings and from the following description of preferred embodiments with reference to the drawings. In this case, the drawings illustrate merely exemplary embodiments of the invention which do not limit the essential concept of the invention.

### BRIEF DESCRIPTION OF THE DRAWINGS

FIG. 1 shows a schematic cross-sectional view of a single serve capsule according to one exemplary embodiment of the present invention.

FIGS. 2a, 2b show schematic views of a system and of a method for producing a beverage according to one exemplary embodiment of the present invention.

FIGS. 3a, 3b show schematic views of a method for producing a single serve capsule according to one exemplary embodiment of the present invention.

### EMBODIMENTS OF THE INVENTION

In the various figures, identical parts are always provided with the same reference signs and are therefore also each only mentioned once as a rule.

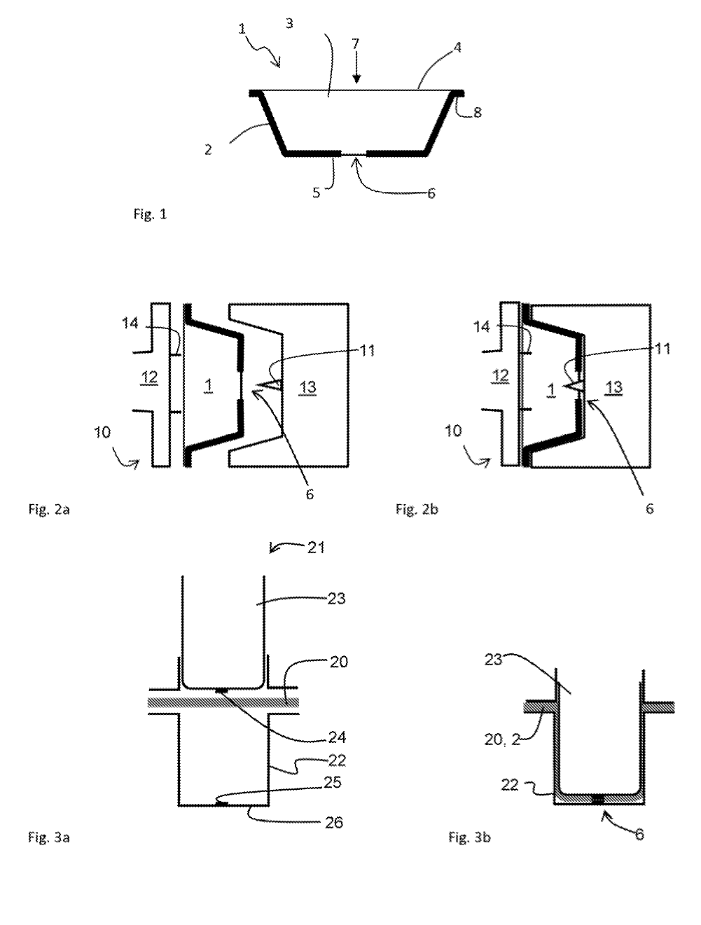

FIG. 1 illustrates a schematic cross-sectional view of a single serve capsule 1 according to one exemplary embodiment of the present invention.

The single serve capsule 1 in this case has a substantially rigid or semirigid frustoconical main capsule body 2 with a capsule bottom 5 and a filling opening 7. In the region of the filling opening 7, the encircling side wall of the main capsule body 2 ends with an encircling flange 8. The filling opening 7 serves to fill a cavity 3 in the interior of the single serve capsule 1 with a beverage raw material. The cavity 3 is then closed off in an airtight manner by a membrane 4, wherein the edge of the membrane 4 is sealed onto the flange 8. The beverage raw material comprises in particular coffee powder or coffee granules (preferably ground roasted coffee), chocolate powder, milk powder, tea, soup powder, instant powder or the like.

The capsule bottom 5 has a central weakened region 8 which is formed by the capsule bottom 5 having a smaller material thickness in the weakened region 6 compared with the material thickness of the remaining capsule bottom 5. The weakened region 6 is formed where the single serve capsule 1, when used, is perforated by a perforation means 11 of the beverage production machine 10 (see FIGS. 2a and 2b) to produce a beverage outlet. As a result of the smaller material thickness in the weakened region 6, the perforation process, or the production of the beverage outlet, is favored.

Preferably, the single serve capsule 1 has a filter element (not illustrated) which is located within the cavity 3, between the beverage raw material and the capsule bottom 5. The filter element comprises in particular a fitter nonwoven or a filter felt, wherein the filter nonwoven or the filter felt is optionally calendered.

On the underside of the capsule bottom 5, the main capsule body 2 optionally has, at the circumference of the capsule bottom 5, an encircling reinforcement bulge 9 which protrudes outward in an opposite direction to the membrane 5.

FIGS. 2a, 2b show schematic views of a system and of a method for producing a beverage according to one exemplary embodiment of the present invention. The system has the single serve capsule 1 already described with reference to FIG. 1, and a beverage production machine 10.

In the present example, the beverage production machine 10 comprises a first brewing chamber element 12 and a second brewing chamber element 13. The first brewing chamber element 12 is displaceable relative to the second brewing chamber element 13 between a loading position illustrated in FIG. 2a and a working position illustrated in FIG. 2b. In the loading position, the first brewing chamber element 12 is spaced apart from the second brewing chamber element 13 such that the single serve capsule 1 is introducible into the beverage production machine 10 and between the first and second brewing chamber elements 12, 13, for example from above using the force of gravity. Subsequently, the first brewing chamber element 12 is displaced in the direction of the second brewing chamber element 13 until the first and second brewing chamber elements 12 and 13 jointly form a closed brewing chamber in which the single serve capsule 1 is arranged.

The second brewing chamber element 13 is provided with a central perforation means 11, while the first brewing chamber element 12 has a plurality of further perforation means 14. When the brewing chambers are closed, the further perforation means 14 penetrate the membrane 4 of the single serve capsule 1 in order to produce inlet openings for introducing brewing water into the single serve capsule 1. At the same time, the central perforation means 11 on the second brewing chamber element 13 perforates the capsule bottom 4, specifically precisely in the weakened region 6. As a result, a beverage outlet is formed in the capsule bottom 5, through which the beverage produced in the single serve capsule 1 by interaction between the brewing water and the beverage raw material can flow out of the single serve capsule 1.

FIGS. 3a, 3b show schematic views of a method for producing a single serve capsule 1 according to one exemplary embodiment of the present invention. The single serve capsule 1 to be produced is substantially the same as the single serve capsule 1 illustrated in FIG. 1, In a first production step (cf, FIG. 3a), a starting material 10 comprising plastics material is introduced into a thermoforming tool 21. The thermoforming tool 21 comprises a mold 22 and a stamp 23 that is movable relative to the mold 22. Arranged centrally at the lower end of the stamp 23 is a shaping element 24. The underside of the mold 22 forms a stamp counterpart 26 which, in the present example, is formed integrally with the mold 22. The stamp counterpart 28 likewise has a central further shaping element 25 here.

In the second production step (cf. FIG. 3b), the stamp 23 is now moved into the mold 22 such that the starting material 20 is deformed or thermoformed into the cylindrical main capsule body 2 by plastic deformation. Optionally, the thermoforming tool 21 is heated before or during the second production step in order to encourage the plastic deformation of the starting material 20. In this third production step, the stamp 23 is moved as far as the inner end of the mold 22 until the shaping element 24 and the further shaping element 25 virtually come into contact with one another. In the region of the two shaping elements 24, 26, material is displaced by the two shaping elements 24, 25 during thermoforming, such that the weakened region with a reduced material thickness is formed in the capsule bottom 5.

Alternatively, the shaping element 24 or the further shaping element 25 can also be configured in the form of a recess in which the opposite shaping element 24, 25 engages.

Furthermore, it is also possible, alternatively to the stamp 23, for the starting material 20 to be drawn into the mold 22 by negative pressure or to be pressed into the mold 22 by positive pressure.

It may also be conceivable for the shaping element 24 to be configured in a movable manner relative to the stamp 23 and to be extended from the stamp 23 in the second production step to form the weakened region. Similarly, the further shaping element 25 could also be designed to be extendable from the mold bottom, or the stamp counterpart 26.

In a further alternative, the shaping element 25 comprises a nozzle which, in the second production method, displaces material by means of positive pressure or negative pressure in order to form the weakened region 6.

In further production steps that are not illustrated, the main capsule body 2 is removed from the thermoforming toot 21, filled with beverage raw material and subsequently closed off by the membrane 4 being sealed onto the flange 8.

1. ) A single serve capsule for producing a beverage in a beverage production machine, the single serve capsule comprising
a substantially frustoconical or cylindrical main capsule body, which has a cavity for accommodating a beverage raw material, and
a membrane closing off the cavity,
wherein the main capsule body has a capsule bottom,
wherein a central weakened region with a reduced material thickness is formed in the capsule bottom, said the weakened region being able to be perforated with the aid of a perforation means of the beverage production machine,
wherein the main capsule body is produced by thermoforming a starting material comprising a plastics material with application of heat such that the region of reduced material thickness for forming the weakened region is formed in the capsule bottom,
wherein the weakened region is formed is a substantially circular manner, and
wherein a diameter of the weakened region is between 10 and 25 percent of a diameter of the capsule bottom.

2. (canceled)

3. The single serve capsule as claimed in claim 1, wherein the single serve capsule is formed in a filter-free manner, and
wherein the beverage raw material rests in particular directly on the capsule bottom

4. (canceled)

5. The single serve capsule as claimed in claim 1, wherein the diameter of the weakened region is between 4 and 7 millimeters.

6. The single serve capsule as claimed in claim 5, wherein the diameter of the capsule bottom spans 25 to 35 millimeters.

7. The single serve capsule as claimed in claim 1, wherein a material thickness in the weakened region is between 20 and 70 percent of a material thickness in the region of the remaining capsule bottom.

8. The single serve capsule as claimed in claim 1, wherein an encircling reinforcement bulge is formed at a circumference of the capsule bottom, which protrudes outward in an opposite direction to the membrane.

9. A method for producing the single serve capsule as claimed in claim 1, comprising:
a first production step comprising: arranging a starting material comprising a plastics material in a region of a mold of a thermoforming tool,
a second production step comprising, moving the starting material into the mold by means of negative pressure and/or by means of a stamp, with a result that the frustoconical or cylindrical main capsule body is formed from the starting material,
wherein, in the second production step, material in a region of the capsule bottom is displaced by means of at least one shaping element to form the weakened region.

10. The method as claimed in claim 9, wherein the shaping element is arranged centrally on the stamp or on the mold.

11. The method as claimed in claim 9 wherein, in the second production step, the stamp is moved as far as a stamp counterpart, and wherein the shaping element is formed on the stamp counterpart.

12. The method as claimed in wherein claim 9, wherein the stamp is formed in a cylindrical or frustoconical manner, and/or wherein the shaping element comprises a bulge or a recess on the stamp or on the mold.

13. A system comprising:
a beverage production machine, and
the single serve capsule as claimed in 1,
wherein the beverage production machine has a first and a second brewing chamber element,
wherein the first and/or the second brewing chamber element is/are movable between a loading position, in which the first and the second brewing chamber element are spaced apart from one another in order to introduce the single serve capsule into the beverage production machine, and a working position, in which the first and the second brewing chamber element have been moved together in order to form a substantially closed brewing chamber, and
wherein the second brewing chamber element has the perforation means protruding in a direction of the first brewing chamber element, perforation means is configured to penetrate the capsule bottom in the weakened region when the beverage production machine is transferred from the loading position into the working position to produce a beverage outflow.

14. The system as claimed in claim 13, wherein the first brewing chamber element has a plurality of further perforation means protruding in the direction of the second brewing chamber element, the further perforation means penetrating the membrane when the beverage production machine is transferred from the loading position into the working position to form inlet openings.

15. (canceled)

16. The single serve capsule as claimed in claim 1, wherein the diameter of the weakened region is between 15 and 20 percent of the diameter of the capsule bottom.

17. The single serve capsule as claimed in claim 1, wherein the diameter of the weakened region is 17 percent of the diameter of the capsule bottom.

18. The single serve capsule as claimed in claim 1, wherein the diameter of the weakened region is between 4.5 and 6 millimeters.

19. The single serve capsule as claimed in claim 1, wherein the diameter of the weakened region is substantially 5 millimeters.

20. The single serve capsule as claimed in claim 5, wherein the diameter of the capsule bottom spans 28 to 32 millimeters.

21. The single serve capsule as claimed in claim 5, wherein the diameter of the capsule bottom spans substantially 30 millimeters.

22. The single serve capsule as claimed in claim 1, wherein a material thickness in the weakened region is between 30 and 60 percent of a material thickness in the region of the remaining capsule bottom.

23. The single serve capsule as claimed in claim 1, wherein a material thickness in the weakened region is substantially 50 percent of a material thickness in the region of the remaining capsule bottom.
